(19) United States
(12) Patent Application Publication
(10) Pub. No.: US 2017/0026573 A1
(43) Pub. Date: Jan. 26, 2017

(54) HIGH-RESOLUTION CCTV PANORAMIC CAMERA DEVICE

(71) Applicant: CPRO Electronic Co., Ltd., Seongnam-si (KR)

(72) Inventor: Young Soo LEE, Seongnam-si (KR)

(21) Appl. No.: 14/878,549

(22) Filed: Oct. 8, 2015

(30) Foreign Application Priority Data
Jul. 22, 2015 (KR) 10-2015-0104017

(51) Int. Cl. H04N 5/232; H04N 5/265; H04N 7/18; H04N 7/015; H04N 5/262; H04N 5/247; H04N 5/77

(52) U.S. Cl. CPC H04N 5/23238; H04N 5/247; H04N 5/265; H04N 5/77; H04N 7/015; H04N 5/2628; H04N 5/23296; H04N 7/181; G06T 2210/22

(57) ABSTRACT

A high-resolution CCTV panoramic camera device is provided. The high-resolution CCTV panoramic camera device includes a plurality of lenses; a plurality of image sensors, installed to correspond to the plurality of lenses, for taking images incident through the plurality of lenses; a video signal conversion unit comprising a plurality of video processors for receiving a plurality of image signals having specific resolution, taken by and output from the plurality of image sensors, and for converting the plurality of image signals into video signals; a panoramic image synthesis unit for synthesizing the plurality of adjacent video signals output from the plurality of video processors of the video signal conversion unit to form a panoramic video image; and a video image output unit for converting the panoramic video image output from the panoramic image synthesis unit into a compressed format to be output.

### CROSS-REFERENCE TO RELATED APPLICATION(S)

This application claims the benefit under 35 U.S.C. §119(a) of a Korean patent application filed on Jul. 22, 2015 in the Korean Intellectual Property Office and assigned Serial number 10-2015-0104017, the entire disclosure of which is hereby incorporated by reference.

### TECHNICAL FIELD OF THE INVENTION

The present invention generally relates to a high-resolution CCTV panoramic camera device. More particularly, the present invention relates to a high-resolution CCTV panoramic camera device, which comprises three lenses and three image sensors and processes images from the three sensors as a single Full HD image signal through a panoramic image synthesis unit (FPGA), whereby a wide range of images without distortion may be obtained as surveillance images.

### BACKGROUND

Generally, a surveillance camera of a Closed Circuit Tele-Vision (CCTV) is a device for capturing and recording the images of scenes by being installed on the walls or the ceilings of a structure, in order to surveil visitors in public buildings, banking facilities, etc. Such a CCTV surveillance camera uses a television system method, in which transmission sides and reception sides are connected to each other with or without wires, for transmitting images to specific receivers, thus the general public excluding the people concerned cannot freely receive the relevant images. This CCTV surveillance camera may apply a method using an adjustable lens, in which a focus and a zoom are adjusted by moving the lens to precisely capture the image of an object, or a method using a fixed-focus lens of which the focal distance is fixed.

FIG. 1 is a block diagram illustrating the configuration of a conventional CCTV camera device according to the related art.

As illustrated in FIG. 1, the conventional CCTV camera may generally be configured to include a lens 11, an image sensor 12 for capturing images, and an image processor 13 for converting the signals output from the image sensor 12 into a video image. Also, a video image output unit 14 for outputting the video image in a specific way may be included after the image processor 13, as the post-processor of the image processor 13. Here, the image processor 13 may use an Image Signal Processor (ISP) or a Digital Signal Processor (DSP), and the video image output unit 14 may be configured as a processor for converting video images to be suitable for various output methods such as a Composite Video Blanking and Sync (CVBS) method, a Serial Digital Interface (SDI) method, an Internet Protocol (IP) method, and the like, according to a video-image outputting method.

Such a conventional CCTV camera device uses a single image sensor 12 and a single lens 11 adapted to the image sensor. In this case, depending on the focal distance of the lens 11, the angle of view may be determined in a range from 20 or 30 degrees to 180 degrees, but a lens 11 of which the angle of view ranges from 60 to 120 degrees is generally used. This is because when the angle of view of the lens 11 is very narrow, the angle of viewing an object becomes very narrow, whereas when the angle of view of the lens 11 is wider than 120 degrees, the surrounding area of an image may be distorted excluding the center area.

Meanwhile, it is desirable to use a lens having a wider angle of view in order to surveil a wider area. Accordingly, it is necessary to decrease the distortion of an image. To this end, a panoramic camera may be used.

FIG. 2 is a block diagram illustrating the configuration of a conventional panoramic camera device according to the related art, and FIG. 3 illustrates an example in which the conventional panoramic camera device outputs three images according to the related art.

As illustrated in FIG. 2, a conventional panoramic camera device comprises three lenses 21, three image sensors 22, an image processor 23, and a video image output unit 24. Here, the three image sensors 22 are arranged to be spaced by 60 degrees, and the three lenses 21 are mounted in the three image sensors 22, respectively. Accordingly, a single image without distortion is produced by synthesizing the images from the three image sensors, and then is output. However, in the case of the conventional panoramic camera device, when the resolution of each of the image sensors is 1920×1080 corresponding to a full HD standard, the single image processor 23 (ISP) processes data of this resolution in the speed of 30 fps (25 fps) or 60 fps. Accordingly, when data from the three image sensors 22 are output via a single display, the area allocated for outputting the data of each of the sensors must be decreased to ⅓. Consequently, the total angle of view is extended by three times, but the scale of each of the outputs is decreased to ⅓, as illustrated in FIG. 3. In other words, a wider area may be surveilled, but the size of the observing target in the image is decreased, thus it is difficult to look closely at the target object. To solve such a problem, a zoom function, which zooms in or zooms out on the target object, may be used. However, when zooming in, the visible area becomes narrower, whereas when zooming out, the visible area becomes wider but it is difficult to obtain a detailed view. In other words, regardless of methods used by the conventional panoramic camera device, a commonly used Codec chip for IP chipset only allows an input format that corresponds to the output area of a single sensor of which the maximum resolution is full HD (1920×1080). As a result, even if a panoramic camera uses multiple sensors, it is difficult to record images from the multiple sensors without the loss of resolution. In other words, the three image sensors are used but the images downscaled to the resolution of a single image sensor are recorded.

### SUMMARY

Accordingly, the present invention has been made keeping in mind the above problems occurring in the related art, and an object of the present invention is to provide a high-resolution CCTV panoramic camera device, which converts three image signals received from three image sensors into three video signals using three video processors, and which synthesizes the three video signals to output a single panoramic video image signal using a panoramic image synthesis unit (FPGA), whereby a wide range of images without distortion may be obtained as surveillance images and the three images from the three images sensors may be recorded without the loss of resolution.

Also, another object of the present invention is to provide a high-resolution CCTV panoramic camera device, which displays a panoramic image, obtained by synthesizing three video signals, in the lower part of a screen; displays an image, obtained by zooming in on a specific area of the panoramic image, in the area corresponding to ⅔ of the screen; and enables the whole image and the enlarged image to be displayed simultaneously on a single screen through an image synthesis process performed by a panoramic image synthesis unit (FPGA). Accordingly, the whole area of the image can be easily observed at a glance, and the area that a user wants to closely monitor can be observed through the enlarged image.

Also, a further object of the present invention is to provide a high-resolution CCTV panoramic camera device, which displays a panoramic image, obtained by synthesizing the outputs of the three image sensors, in real time, but separately records the outputs of the three image sensors without the loss of resolution for special use. Accordingly, when an accident occurs and scene analysis is required, the outputs of the three image sensors, recorded in high resolution, may be used instead of the image of which the resolution is decreased to ⅓ by synthesizing the outputs of the three image sensors.

In order to accomplish the above object, a high-resolution CCTV panoramic camera device according to the present invention includes: three lenses; three image sensors, installed to correspond to the three lenses, for taking images incident through the lenses; a video signal conversion unit comprising three video processors for receiving three image signals having specific resolution, taken by and output from the three image sensors, and for converting the three image signals output from the three image sensors into three video signals, respectively; a panoramic image synthesis unit for obtaining a panoramic video image by synthesizing the three adjacent video signals output from the three video processors of the video signal conversion unit; and a video image output unit for converting the panoramic video image output from the panoramic image synthesis unit into a compressed format to be output.

The three lenses are arranged to observe an area with 180 degrees angle of view, and each of the lenses may have a view angle that ranges from 60 to 90 degrees.

Each of the three image sensors outputs image signals to meet a standard of full HD resolution (1920×1080), but the image sensors may be configured as a sensor with vertical resolution of 1200 higher than 1080.

The panoramic image synthesis unit may be implemented as a Field Programmable Gate Array (FPGA) for synthesizing the three video signals output from the three video processors and for outputting a panoramic video image signal having full HD resolution (1920×1080).

When three video signals, received from the three video processors of the video signal conversion unit, are processed as three images and when the three images are simultaneously displayed, the panoramic image synthesis unit controls a signal synthesis process to display the three images in a single screen by downscaling an output of each of the sensors to ⅓, and the three images, downscaled to ⅓, may be output in a panorama area arranged in a lower part of the screen, and a partial image, selected from a whole image and zoomed in, may be output in a zoom area arranged in an upper part of the screen, the panorama area having a height corresponding to ⅓ of vertical resolution of the screen and the zoom area occupying a remaining ⅔ of the screen.

The panoramic image synthesis unit may synthesize images by cropping an area overlapped between adjacent images output from the sensors in terms of horizontal resolution, and may adjust start positions of the adjacent images output from the sensors to match vertical resolution of the images.

A method for cropping the area overlapped in a lateral direction between the adjacent images output from the sensors and for joining the adjacent images is controlled by an FPGA chip rather than by a mechanism, and a user may align the images output from the sensors horizontally by configuring menu items using a SW interface and by executing the menu items on a monitor. Also, a method for matching the images output from the three sensors in a vertical direction is controlled by the FPGA chip, and the user may match the images in the vertical direction by configuring menu items using a SW interface and by moving up or down the images on the monitor using the menu items.

The panoramic image synthesis unit may include an auto-calibration function for automatically overlapping video signal data from different sensors, a function for forming one image by processing images of video signals in order to output a video image obtained by zooming in on a specific area of an image along with the original image, and a function for displaying a partial image including a motion in a zoom area arranged in an upper part of a screen by automatically scrolling the screen, the motion being detected by a motion detection function and the motion detection function detecting a moving object in a video image displayed in a panorama area arranged in a lower part of the screen.

The panoramic image synthesis unit synthesizes video signals to form a panoramic video image, and separates the panoramic video image and three video signals output from the three video processors into a panorama output image, a first sensor output image, a second sensor output image, and a third sensor output image, and sequentially and repeatedly transmits the separated images to the video image output unit using a time-division input method.

The video image output unit separates the four different images, sequentially and repeatedly input through the time-division input method, by analyzing identification codes included in the panorama output image, the first sensor output image, the second sensor output image, and the third sensor output image, and stores the four different images as four different video clips by processing the images.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the configuration of a conventional CCTV camera device according to the related art;

FIG. 2 is a block diagram illustrating the configuration of a conventional panoramic camera device according to the related art;

FIG. 3 illustrates an example in which a conventional panoramic camera device outputs three images according to the related art;

FIG. 4 is a block diagram illustrating the configuration of a high-resolution CCTV panoramic camera device according to an embodiment of the present invention;

FIG. 5 illustrates the arrangement of the lenses of a high-resolution CCTV panoramic camera device according to an embodiment of the present invention; and

FIG. 6 illustrates an example in which a high-resolution CCTV panoramic camera device according to an embodiment of the present invention outputs three images.

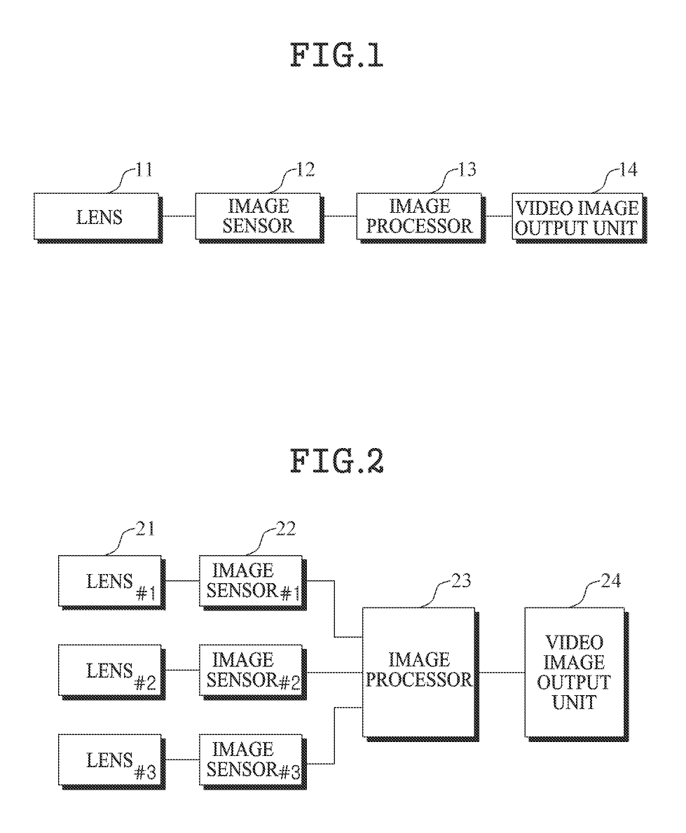

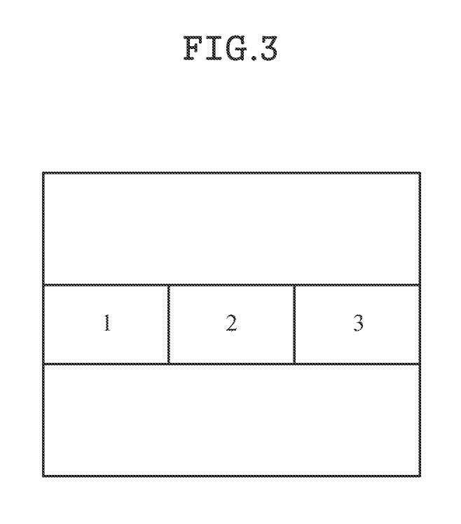

### DETAILED DESCRIPTION

Hereinafter, preferred embodiments will be described in order to enable those of ordinary skill in the art to embody and practice the invention with reference to the accompanying drawings. Repeated descriptions and descriptions of known functions and configurations that have been deemed to make the gist of the present invention unnecessarily obscure will be omitted below. Also, the same reference numbers will be used throughout the drawings to refer to the same or like parts of which redundant details shall be omitted.

It will be understood that when an element is referred to as being “connected” or “coupled” to another element, it can be directly connected or coupled to the other element or intervening elements may be present. Also, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

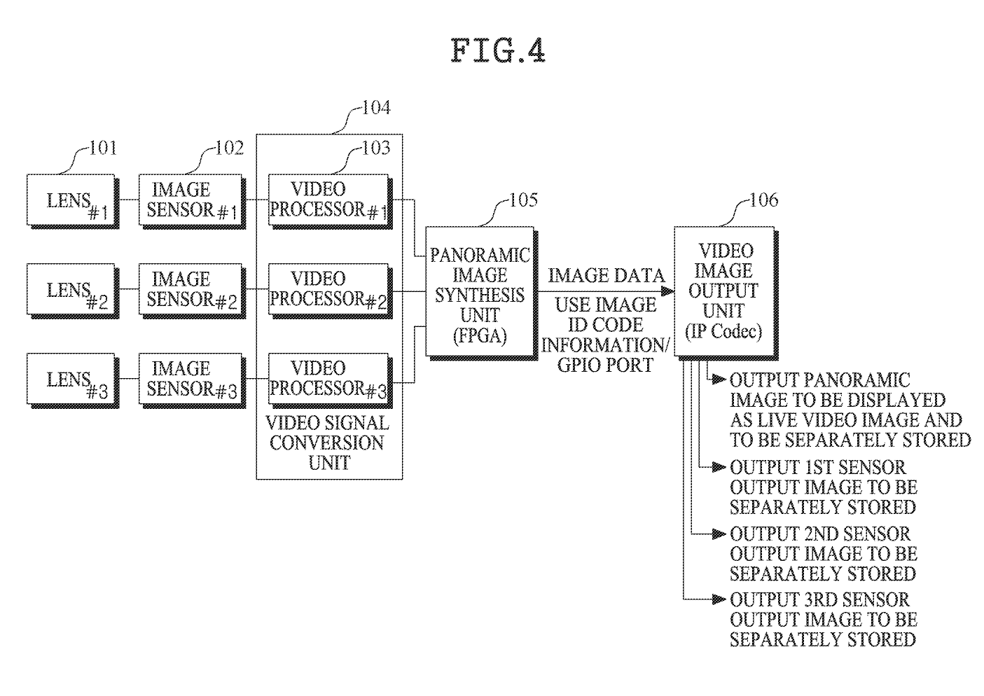

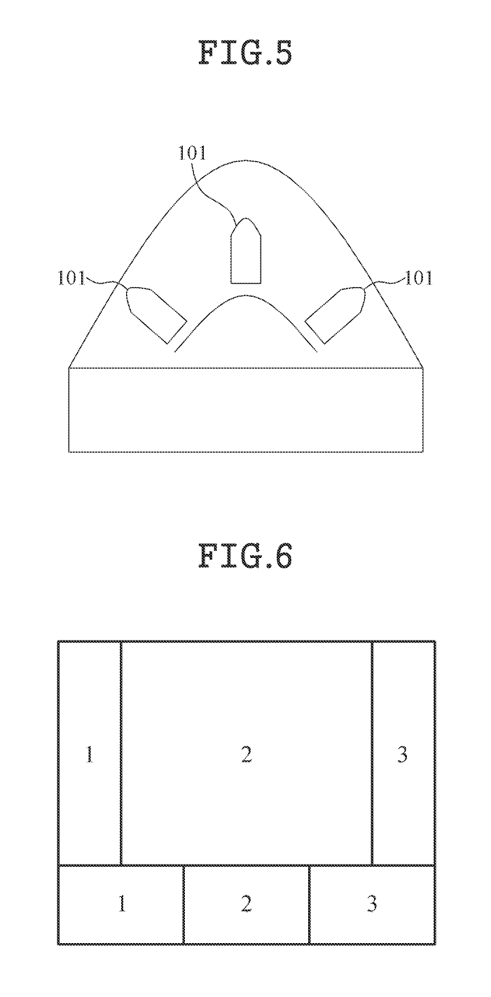

FIG. 4 is a block diagram illustrating the configuration of a high-resolution CCTV panoramic camera device according to an embodiment of the present invention; FIG. 5 illustrates the arrangement of lenses of a high-resolution CCTV panoramic camera device according to an embodiment of the present invention; and FIG. 6 illustrates an example in which a high-resolution CCTV panoramic camera device according to an embodiment of the present invention outputs three images. As illustrated in FIG. 4, a high-resolution CCTV panoramic camera device according to an embodiment of the present invention may be configured to include a lens 101, an image sensor 102, a video signal conversion unit 104, a panoramic image synthesis unit 105, and a video image output unit 106.

The lens 101 comprises three lenses 101 in order to implement the panoramic camera device. As illustrated in FIG. 5, the three lenses 101 are arranged to observe an area with an angle of view of total 180 degrees. Each of the lenses 101 has a view angle that ranges from 60 to 90 degrees. Here, the areas overlapped due to the range of the view angle of the three lenses 101 are processed by the panoramic image synthesis unit 105, which will be described later.

The image sensor 102 comprises three images sensors 102. The three image sensors 102 are installed to correspond to the three lenses 101, respectively, and take images incident through the lenses 101. Each of the three image sensors 102 outputs image signals to meet a standard for full HD resolution (1920×1080), but the sensors may be configured as a sensor of which the vertical resolution is 1200, which is higher than 1080.

The video signal conversion unit 104 comprises three video processors 103. The three video processors 103 receive three image signals having specific resolution as inputs, which are taken by and output from the three image sensors 102, respectively, and convert the input image signals into video signals. Namely, the video signal conversion unit 104 serves to generate normal video signals using the three video processors 103 by receiving the image signals, output from the three image sensors 102.

The panoramic image synthesis unit 105 synthesizes the three adjacent video signals, output from the three video processors 103 of the video signal conversion unit 104, to form a panoramic video image. Namely, the panoramic image synthesis unit 105 may receive three video signals having specific resolution, which are output from the three video processors 103, and may output a single image signal through a signal synthesis process in which the maximum resolution is set to be identical to the specific resolution of one of the image sensors 102. This panoramic image synthesis unit 105 may be implemented by a Field Programmable Gate Array (FPGA) that synthesizes three video signal data output from the three video processors 103 and outputs a panoramic video image signal having full HD resolution (1920×1080).

Also, when three video signals, received from the three video processors 103 of the video signal conversion unit 104, are processed as three images and when the three images are simultaneously displayed, the panoramic image synthesis unit 105 controls the signal synthesis process in order to downscale the output of each of the sensors to ⅓ thereof. In this case, the three images downscaled to ⅓ thereof may be displayed in a panorama area arranged in the lower part of the screen, and a partial image, which is selected from the whole image and then is zoomed in, is output in a zoom area arranged in the upper part of the screen. Here, the panorama area is arranged to have the height corresponding to ⅓ of the vertical resolution of the screen, and the zoom area occupies the remaining ⅔ of the screen. In other words, as illustrated in FIG. 6, the signal synthesis process is controlled to display all the three outputs of the sensors on a single screen by downscaling the output of each of the sensors to ⅓. Also, a single video signal, obtained by synthesizing the outputs of the sensors, is processed as a single image to be displayed in the remaining ⅔ area, namely, the single image may be displayed in the zoom area.

Also, the panoramic image synthesis unit 105 outputs an image signal having full HD resolution (1920×1080), which is synthesized to have an angle of view of 180 degrees. In terms of horizontal resolution, the panoramic image synthesis unit 105 synthesizes the images by cropping an area overlapped between adjacent images output from the sensors. In terms of vertical resolution, the panoramic image synthesis unit 105 adjusts the start position of the adjacent images to match the vertical resolution thereof. The panoramic image synthesis unit 105 may include an auto-calibration function for automatically overlapping the video signal data of different sensors, a function for synthesizing a video image with another video image that is obtained by zooming in on the specific area of the original video image to display the two video images on the same screen, and a function for outputting a partial image, which includes a motion detected by a motion detection function, in the zoom area arranged in the upper part of the screen and for displaying the partial image by automatically scrolling the screen, the motion detection function detecting a moving object in the whole panoramic image output in the panorama area arranged in the lower part of the screen.

Also, the panoramic image synthesis unit 105 synthesizes video signals to form a panoramic video image, and separates the panoramic video image and the three video signals output from the three video processors 103 into a panorama output image, a first sensor output image, a second sensor output image, and a third sensor output image. Then, using a time-division method, the panoramic image synthesis unit 105 may sequentially and repeatedly transmit the separated images to the video image output unit 106.

Because the monitor specification usually used in the monitor market has maximum resolution of 1920×1080 as a full HD standard, images having resolution higher than the maximum resolution may not be displayed on the monitor. Therefore, in the present invention, whenever image signals are output by the video signal conversion unit 104, which comprises three image processors 103 for converting the outputs of the three image sensors 102 into video signals, and by the panoramic image synthesis unit 105, which synthesizes the video images, the maximum resolution of the output image signals is adjusted to be identical to the resolution (1920×1080) of a single image sensor 102. Namely, even if the three images from the sensors are simultaneously output by being arranged in a row, or even if a specific area of the images is output by being enlarged, the output is always processed to have the maximum resolution identical to the resolution of a single sensor. Therefore, the video image output unit 106, installed after the panoramic image synthesis unit, regards the three images sensors as a single image sensor 102, thus a general IP Codec (for image compression) on the market can be used without modification. In other words, though there are three image sensors 102, the present invention may run the IP Codec of the video image output unit 106 as if there were only one image sensor, and may display the video images of the image sensors 102.

The video image output unit 106 serves to convert the panoramic video image, output from the panoramic image synthesis unit 105, into a compressed format to be output. The video image output unit 106 may analyze identification codes respectively included in the panorama output image, the first sensor output image, the second sensor output image, and the third sensor output image, and may separate images, sequentially and repeatedly input through a time-division method, into four different video images according to the identification codes included therein. Then, the separated four different images may be processed as four different videos. In other words, the video image output unit 106 receives four different images, namely, a single panoramic image transmitted from the panoramic image synthesis unit 105, the first sensor output image, the second sensor output image, and the third sensor output image, analyzes identification codes respectively included in the images to separate the four output images, and processes the four output images as four different videos by separating the images sequentially input through the time-division method. In this case, compared to the case in which one video is input, the number of the frames of a video is decreased to ¼ because four different video images are sequentially and repeatedly input through a time-division method. However, because resolution is more important than the number of video frames in order to analyze video footage of a site when an accident occurs, the loss of resolution, which is the disadvantage of the conventional art, may be prevented and the outputs of the three image sensors may be stored. Consequently, the present invention enables a user to easily observe surveillance images at a glance by displaying the panoramic image as the live video image on the monitor, and records all of the first sensor output image, the second sensor output image, and third sensor output image, to be used for scene analysis when it is necessary to observe video footage of a site in detail.

In the high-resolution CCTV panoramic camera device according to an embodiment of the present invention, a method for cropping the image overlapped in the lateral direction between the outputs of the sensors and a method for joining the adjacent images are controlled by an FPGA chip rather than by a mechanism, and a user may align the images output from the sensors horizontally by configuring menu items using a SW interface and by executing the menu items on the monitor. Also, matching the images, output from the three sensors, in the vertical direction is controlled by the FPGA chip, and the user may adjust the location of the images by configuring menu items using a SW interface and by moving up and down the images on the monitor using the menu items. Also, the high-resolution CCTV panoramic camera device may provide an auto-calibration function for automatically overlapping video data of different sensors, a function for generating a single image through image processing in order to output a video image obtained by zooming in on the specific area of an image along with the original image, and a function for automatically displaying a partial image including a motion, detected by a motion detection function, in the zoom area arranged in the upper part of the screen, the motion detection function detecting a moving object in the video image displayed in the panorama area arranged in the lower part of the screen. Also, the panoramic image, the first sensor output image, the second sensor output image, and the third sensor output image are sequentially transmitted from the FPGA chip, which is designed for processing the four images using the time-division method, to the IP Codec chip, whereby the four different images are recorded and the loss of resolution may be prevented.

According to a high-resolution CCTV panoramic camera device proposed by the present invention, three image signals received from three image sensors are converted into three video signals using three video processors, and a panoramic image synthesis unit (FPGA) for synthesizing the three video signals is configured to output a single panoramic video image signal. Accordingly, a wide range of images without distortion may be obtained as surveillance images and the three images from the three images sensors may be recorded without the loss of resolution.

Also, according to the present invention, a panoramic image obtained by synthesizing three video signals is displayed in the lower part of a screen, and an image obtained by zooming in on a specific area of the panoramic image is displayed in the area corresponding to ⅔ of the screen. Accordingly, the whole area of the image can be easily observed at a glance, and the area that a user wants to closely monitor can be observed through the enlarged image. Also, a panoramic image synthesis unit (FPGA) performs an image synthesis process to enable the whole image and the enlarged image to be displayed simultaneously on a single screen.

Furthermore, the present invention enables displaying a panoramic image, obtained by synthesizing the outputs of the three image sensors, in real time, but separately recording the outputs of the three image sensors without the loss of resolution. Accordingly, when an accident occurs and scene analysis is required, the outputs of the three image sensors, recorded in high resolution, may be used instead of the image of which the resolution is decreased to ⅓ by synthesizing the outputs of the three image sensors.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A high-resolution CCTV panoramic camera device, comprising:
a plurality of lenses;
a plurality of image sensors, installed to correspond to the plurality of lenses, for taking a plurality of images incident through the plurality of lenses;
a video signal conversion unit comprising a plurality of video processors for:
receiving a plurality of image signals having specific resolution, taken by and output from the plurality of image sensors, and
converting the plurality of image signals output from the plurality of image sensors into a plurality of video signals, respectively;
a panoramic image synthesis unit for obtaining a panoramic video image by synthesizing the plurality of adjacent video signals output from the plurality of video processors of the video signal conversion unit; and
a video image output unit for converting the panoramic video image output from the panoramic image synthesis unit into a compressed format to be output.

2. The high-resolution CCTV panoramic camera device of claim 1,
wherein the plurality of lenses are arranged to observe an area with 180 degrees angle of view, and each of the plurality of lenses has a view angle that ranges from 60 to 90 degrees.

3. The high-resolution CCTV panoramic camera device of claim 1,
wherein each of the plurality of image sensors outputs the plurality of image signals to meet a standard of full HD resolution (1920×1080), but the plurality of image sensors are configured as a sensor with vertical resolution of 1200 higher than 1080.

4. The high-resolution CCTV panoramic camera device of claim 1,
wherein the panoramic image synthesis unit is implemented as a Field Programmable Gate Array (FPGA) for synthesizing the plurality of video signals output from the plurality of video processors and for outputting a panoramic video image signal having full HD resolution (1920×1080).

5. The high-resolution CCTV panoramic camera device of claim 4,
wherein, when the plurality of video signals, received from the plurality of video processors of the video signal conversion unit, are processed as the plurality of images and when the plurality of images are simultaneously displayed, the panoramic image synthesis unit controls a signal synthesis process to display the plurality of images in a single screen by downscaling an output of each of the plurality of sensors to ⅓, and
wherein the plurality of images, downscaled to ⅓, are output in a panorama area arranged in a lower part of the screen, and a partial image, selected from a whole image and zoomed in, is output in a zoom area arranged in an upper part of the screen, the panorama area having a height corresponding to ⅓ of vertical resolution of the screen and the zoom area occupying a remaining ⅔ of the screen.

6. The high-resolution CCTV panoramic camera device of claim 4,
wherein the panoramic image synthesis unit synthesizes the plurality of images by cropping an area overlapped between adjacent images output from the sensors in terms of horizontal resolution, and adjusts start positions of the adjacent images output from the sensors to match vertical resolution of the plurality of images.

7. The high-resolution CCTV panoramic camera device of claim 6,
wherein:
a method for cropping the area overlapped in a lateral direction between the adjacent images output from the sensors and for joining the adjacent images is controlled by an FPGA chip rather than by a mechanism, and a user may align the plurality of images output from the sensors horizontally by configuring menu items using a SW interface and by executing the menu items on a monitor; and
a method for matching the plurality of images output from the plurality of sensors in a vertical direction is controlled by the FPGA chip, and the user may match the plurality of images in the vertical direction by configuring menu items using a SW interface and by moving up or down the plurality of images on the monitor using the menu items.

8. The high-resolution CCTV panoramic camera device of claim 4,
wherein the panoramic image synthesis unit includes an auto-calibration function for automatically overlapping video signal data from different sensors, a function for forming one image by processing the plurality of images of the plurality of video signals in order to output a video image obtained by zooming in on a specific area of an image along with the original image, and a function for displaying a partial image including a motion in a zoom area arranged in an upper part of a screen by automatically scrolling the screen, the motion being detected by a motion detection function and the motion detection function detecting a moving object in a video image displayed in a panorama area arranged in a lower part of the screen.

9. The high-resolution CCTV panoramic camera device of claim 8,
wherein the panoramic image synthesis unit synthesizes the plurality of video signals to form a panoramic video image, and separates the panoramic video image and a plurality of video signals output from the plurality of video processors into a panorama output image, a first sensor output image, a second sensor output image, and a third sensor output image, and sequentially and repeatedly transmits the separated plurality of images to the video image output unit using a time-division input method, and
wherein the video image output unit separates the four different images, sequentially and repeatedly input through the time-division input method, by analyzing identification codes included in the panorama output image, the first sensor output image, the second sensor output image, and the third sensor output image, and stores the four different images as four different video clips by processing the plurality of images.

10. The high-resolution CCTV panoramic camera device of claim 2,
wherein the panoramic image synthesis unit is implemented as a Field Programmable Gate Array (FPGA) for synthesizing the plurality of video signals output from the plurality of video processors and for outputting a panoramic video image signal having full HD resolution (1920×1080).

11. The high-resolution CCTV panoramic camera device of claim 3,
wherein the panoramic image synthesis unit is implemented as a Field Programmable Gate Array (FPGA) for synthesizing the plurality of video signals output from the plurality of video processors and for outputting a panoramic video image signal having full HD resolution (1920×1080).
